(19) United States
(12) Patent Application Publication
(10) Pub. No.: US 2021/0378238 A1
(43) Pub. Date: Dec. 9, 2021

(54) DUAL-ROUTE ADMINISTRATION OF COMPOSITION FOR IMPROVED PROTECTION OF PLANTS AGAINST PATHOGENS

(71) Applicant: GRACE BREEDING LTD., Kfar Saba (IL)

(72) Inventors: Avner BARAZANI, Omer (IL); Amit AVIDOV, Kiryat Tivon (IL)

(21) Appl. No.: 17/286,946

(22) PCT Filed: Oct. 20, 2019
(86) PCT No.: PCT/IL2019/051136

§ 371 Date: Apr. 20, 2021

Related U.S. Application Data
(60) Provisional application No. 62/748,480, filed on Oct. 21, 2018.

(51) Int. Cl. A01N 25/26; A01N 25/02; A01N 63/22

(52) U.S. Cl. CPC A01N 25/26; A01N 63/22; A01N 25/02

(57) ABSTRACT

The present invention provides a method for preventing and/or treating infection of plant species by fungal, mildew-causing, bacterial and/or viral pathogens, wherein said method comprises the steps of a) providing a mixture of one or more non-pathogenic bacteria and one or more activating agents, and b) administering the mixture of step (a) to said plant species, by means of both (i) adding a plurality of granules coated with said mixture to the medium in which said plant is growing, and (ii) applying a foliar spray comprising said mixture to the aerial parts of said plant species.

### FIELD OF THE INVENTION

The present invention relates to an improved method of protecting plant species from pathogenic attack. More specifically, the present invention provides a method by which a protective composition is administered by two different routes.

### BACKGROUND OF THE INVENTION

The use of non-pathogenic soil-borne bacteria for protecting plant and other host species of agricultural and horticultural interest against bacterial and fungal attack is well known in the art. One example of a non-pathogenic bacterial species used in such systems is Bacillus subtilis.

Co-owned international patent application PCT/IL2017/051038 (published as WO 2018/051344) discloses a composition and method for protecting plant and animal species, wherein the composition comprises a mixture of a non-pathogenic bacterial species (preferably B. subtilis) one or more activating agents (preferably compounds having high levels of anti-inflammatory activity). The two components of this mixture act together synergistically, thereby greatly enhancing the anti-bacterial, anti-viral and anti-fungal activities that are seen with either component alone.

However, the present inventors have now found that the high level protective effect caused by provision of the aforementioned synergistic composition may be significantly further enhanced by means of using an improved method of composition delivery.

### SUMMARY OF THE INVENTION

The present invention is primarily directed to an improved method for increasing the ability of a plant or animal host species to resist damage caused by fungal, bacterial and/or viral pathogens and/or by other pathogens, such as mildew-forming organisms. In particular, this aspect of the invention is directed to a method for preventing and/or treating infection of plant species by fungal, mildew-causing, bacterial and/or viral pathogens. In its most general form, this method comprises the steps of:

a) providing a mixture of one or more non-pathogenic bacteria and one or more activating agents; and

b) administering the mixture of step (a) to said plant species, by means of both:
(i) adding a plurality of granules or other formulations containing or coated with said mixture to the medium in which said plant is growing; and
(ii) applying a foliar spray comprising said mixture to the aerial parts of said plant species.

In one embodiment the mixture of step (a) that is added to the plant growth medium in step (b) (i) is contained within and/or on the surface of a plurality of granules.

In one highly preferred embodiment, the non-pathogenic bacteria are bacteria of the species Bacillus subtilis. A particularly preferred strain of B. subtilis is the QST 713 strain.

Although many different activating agents may be used, in particular agents with certain anti-inflammatory properties (as described in co-owned WO 2018/051344), Thus, in one embodiment, the one or more activating agent are substances having anti-inflammatory activity. in one preferred embodiment of the present method, the one or more activating agents are selected from the group consisting of Sclareol, Naringin, Nootkatone, Steviol glycoside and cannabidiol.

In a particularly preferred embodiment of this method, the activating agents comprise a mixture of Sclareol, Naringin, Nootkatone, Steviol glycoside and cannabidiol.

Although the presently-disclosed method may be employed in order to treat or prevent plant diseases caused by many different pathogenic agents, in one preferred embodiment, the infection of the plant species to be prevented and/or treated is caused by a mildew-causing pathogen. Examples of such mildew-causing pathogens include (but are not limited to) organisms of the Peronospora genus. These are organisms belonging to the Oomycetes class, and they (and the lesions that they cause in plant tissues) are commonly known as Downy mildew. In general terms, mildew is a form of fungus that often has the appearance of a thin, superficial growth consisting of minute hyphae on the surface of the leaves. In horticulture, mildew is generally either species of fungus in the Erysiphales order, or fungus-like organisms in the family Peronosporaceae. A further example of an agent causing mildew is Plasmopara viticola, which is responsible for downy mildew in grapevines.

In some other embodiments of the presently-disclosed method, said method further comprises the foliar administration of one or more bactericidal, viricidal, fungicidal and/or herbicidal agents to the plant species. In one preferred embodiment, the additional agents are one or more fungicidal agents. Non-limiting examples of suitable fungicidal agents are given hereinbelow.

In another aspect, the present invention also provides a kit for use in the method defined hereinabove, comprising:
a) A first container containing granules or other formulations containing or coated with a mixture of one or more non-pathogenic bacteria and one or more activating agents; and
b) A second container containing a liquid composition suitable for administration by foliar spraying, comprising one or more non-pathogenic bacteria and one or more activating agents.

In one embodiment, the mixture of bacteria and activating agents in the first container is present within and/or on the surface of a plurality of granules.

In one preferred embodiment of the kit of the present invention, the non-pathogenic bacteria are bacteria of the species Bacillus subtilis.

In one preferred embodiment of the kit of the present invention, the one or more activating agents are selected from the group consisting of Sclareol, Naringin, Nootkatone, Steviol glycoside and cannabidiol.

In one preferred embodiment of the kit of the present invention, the non-pathogenic bacteria are the QST 713 strain of the species Bacillus subtilis, and the activating agents comprise a mixture of Sclareol, Naringin, Nootkatone, Steviol glycoside and cannabidiol.

### BRIEF DESCRIPTION OF THE FIGURES

FIG. 1 is a photograph showing the appearance of mildew on cucumber plant leaves treated with granules containing the combination treatment, but not treated with foliar spray.

FIG. 2 is a photograph showing the appearance of mildew on cucumber plant leaves in the negative control group (no treatment whatsoever).

FIG. 3 is a photograph showing the appearance of cucumber plant leaves that received the combination treatment of the present invention by foliar spray only.

FIG. 4 is a photograph showing the appearance of cucumber plant leaves that received the combination treatment of the present invention both as granules and as a foliar spray.

### DETAILED DESCRIPTION OF PREFERRED EMBODIMENTS

As disclosed hereinabove, the present invention is primarily directed to a method for increasing the ability of a plant or animal host species to resist damage caused by fungal, bacterial and/or viral pathogens and/or by other pathogens, such as mildew-forming organisms, comprising the steps of:
a) providing a mixture of one or more non-pathogenic bacteria and one or more activating agents; and
b) administering the mixture of step (a) to said plant species, by means of both:
   (i) adding a plurality of granules coated with said mixture to the medium in which said plant is growing (i.e. soil or other growth medium); and
   (ii) applying a foliar spray comprising said mixture to the aerial parts of said plant species.

In other words, a key feature of the present invention is the administration of the mixture of bacteria and activating agent by two separate routes (i.e. (i) foliar spray, and (ii) granules or other formulations added to the soil or other growth medium).

In certain cases, the two components mentioned in step (a) of the method defined above (i.e. the non-pathogenic bacteria and the activating agent(s)) may be administered separately.

In the context of the present invention, the term “activating agent” is used to denote a substance which when present in a mixture together with the non-pathogenic bacteria or when delivered separately therefrom, is capable of enhancing the beneficial effects of said non-pathogenic bacterial cells on the treated plant or animal host species. This enhancement may, in some cases, be a result of a synergistic interaction between the non-pathogenic bacteria and the activating agents. In the alternative, the activating agents and the non-pathogenic bacteria may each be devoid of any significant beneficial effect on the host when used alone, but may cause significant anti-microbial, immunostimulatory and/or other beneficial effects in the host species when the two classes of substance are administered together or consecutively.

As reported in co-owned WO 2018/051344, many of the activating agents suitable for use in the method of the present invention share a common feature, namely their ability to inhibit inflammatory mediators that are more generally associated with higher animal species (such as Tumor Necrosis Factor alpha [TNF-α]) rather than with plant species. Thus, in one preferred embodiment of the present invention, the one or more activating agents are substances having anti-inflammatory activity.

As mentioned, it has been found by the present inventors that the aforementioned anti-inflammatory activity that is associated with the activating agents of the present invention is mediated, at least in part, by the inhibition of one or more key inflammatory mediators such as TNF-α and/or nitric oxide (NO). Consequently, in one preferred embodiment of the present invention, the one or more activating agents used in the aforementioned method are substances capable of inhibiting the production of NO and/or TNF-α.

In one further preferred embodiment of the present invention, the activating agents each have an IC₅₀ for the inhibition of NO production of less than 1.5 mg/ml and/or an IC₅₀ for the inhibition of TNF-α production of less than 2.5 mg/ml.

In another preferred embodiment, each individual activating agents (whether used alone or in combination with other such agents) has an IC₅₀ for the inhibition of NO production of less than 0.1 mg/ml and/or an IC₅₀ for the inhibition of TNF-α production of less than 0.2 mg/ml.

In a still further preferred embodiment, each individual activating agents (whether used alone or in combination with other such agents) has an IC₅₀ for the inhibition of NO production of less than 0.05 mg/ml and/or an IC₅₀ for the inhibition of TNF-α production of less than 0.1 mg/ml.

It is to be noted that the use of the IC₅₀ value (i.e. the concentration of an agent which causes 50% of the maximal inhibition of a mediator, agonist or other biologically active molecule) as a means for comparing the potency of antagonists and other biologically- and pharmacologically-active molecules, is well-known to all skilled-artisans in this field. Briefly, the IC₅₀ values may be obtained by plotting dose-response curves for a parameter such as inhibition of a particular inflammatory mediator and extracting said values from said curves.

In another preferred embodiment, the activating agents are selected from the group consisting of Sclareol, Naringin, Nootkatone, Steviol glycoside and cannabidiol and combinations thereof.

In a yet further preferred embodiment, the activating agents (including those having the qualitative and quantitative anti-inflammatory properties disclosed above) are derived from plant material (such as crude plant extracts, such as whole plant aqueous extracts, partially purified or fractionated extracts, purified extracts and synthetic analogues of active molecules present in said extracts).

In one preferred embodiment of this aspect of the invention, the plant-derived activating agents are herbal extracts selected from the group consisting of Aster tataricus, Cyperus rotundus and combinations thereof.

In one preferred embodiment, the host species (i.e. the target species in which the presently disclosed method is used to prevent and/or treat infection) is a plant species, including (but not limited to) vegetables, pulses, grains, tropical species (such as bananas), sub-tropical species (such as citrus fruits), other trees and shrubs, flowering plants of horticultural interest, and so on.

It was disclosed hereinabove that in some implementations of the various methods of the present invention, the non-pathogenic bacteria and the activating agents may be administered separately, that is, one after the other. In such implementations, the first composition to be administered may be either the composition comprising the non-pathogenic bacteria or the composition comprising the one or more activating agents. In certain other embodiments of the type in which the non-pathogenic bacteria and the activating agents are administered separately, both of them are administered to the host species at approximately the same time.

In one preferred embodiment, the granules used in the present method are Perlite granules which have been coated with the substances to be delivered. In some cases, these granules may further comprise a release-control polymer, which is usually present as an exterior coating on the granule surface.

In some embodiments, the mixture of step (a) in the above-defined method is administered to the host organisms to be treated in a continuous manner, for periods of between a few hours and about 180 days.

When the emulsion method is used, the treatment period is generally a few hours and a second treatment may be administered after about 10 days.

When a controlled release membrane or substrate is used, the treatment will take about 180 days. The controlled release substrate may be of several different types. In one preferred embodiment, this substrate is formed into granules, such as Perlite granules, as are well known to the skilled artisan in this technical field. Other options for control release substrates include various pellets, beads, micro-beads, fibers having a water absorbing capacity above 1:15 in relation to their dry weight. In order to achieve the desired controlled-release characteristics, the substrates may be coated with wax, Ethocel, other release-control polymers (as well known in the agricultural, pesticidal and pharmaceutical fields) and plant oils.

In one preferred embodiment, both the granule formulation and the liquid foliar spray formulation may further comprise one or more additional components, including penetrating agents, stabilizers, solvents, sequestrants, emulsifiers and release-control (e.g. slow release) agents.

Examples of suitable penetrating agents—polar aprotic solvents DMSO, DMSO-d6, Dimethylformamide (DUF).

Examples of suitable non-ionic surfactant include Triton X-100, Tergitol 15-S-3, 15-S-5, 15-S-7.

Examples of suitable sequestrants include sodium phosphates, sodium gluconate, calcium chloride, potassium gluconate.

Examples of emulsifiers include polyaldo10-6-O, E-471, E-475, and E-476.

Examples of controlled release agents include coatings comprising dicyclopentadiene and linseed oil or a soy bean oil alkyd (e.g. the commercially-available coating composition sold under the registered trademark Osmocote®, and distributed by ICL Specialty Fertilizers, Israel, and disclosed in U.S. Pat. No. 4,657,576), and the polymer E603 obtainable from Sekisui Specialty Chemicals, Japan.

Of course, the additional components listed above are given only for the sake of illustration, and many other different additives and excipients may also be included in the compositions disclosed herein.

It is to be noted that in some of the preferred embodiments of the present invention, the mixture of activating agents includes both hydrophilic and hydrophobic substances. As a result, it is in many cases necessary to prepare the composition as an emulsified mixture of two separate components: an aqueous portion containing the more water-soluble agents dissolved in water and a hydrophobic portion containing the less water-soluble agents dissolved in fatty acids, medium chain triglycerides, ethanol, other solvents and combinations thereof.

As mentioned hereinabove in the context of the presently-disclosed method, in some other embodiments said method further comprises the foliar administration of one or more bactericidal, viricidal, fungicidal and/or herbicidal agents to the plant species. Generally, said additional agents are administer by foliar spray separately from the foliar spray containing the mixture of non-pathogenic bacteria and activating agents described hereinabove. In one particular set of embodiments, the method comprises the foliar administration of one or more substances having fungicidal activity.

Many different types of fungicidal agents may be administered as part of the embodiment of the invention described immediately hereinabove. The following partial list provides examples of suitable groups of fungicidal agents, as well as specific non-limiting examples of such agents:

A Strobilurin fungicide, such as azoxystrobin, dimoxystrobin, fluoxastrobin, kresoxim-methyl, metominostrobin, orysastrobin, picoxystrobin, pyraclostrobin, trifloxystrobin, cyzofamid; an azole fungicide, such as azaconazole, bromuconazole, cyproconazole, difenoconazole, diniconazole, diniconazole-M, epoxiconazole, fenbuconazole, fluquinconazole, flusilazole, flutriafol, hexaconazole, imazalil, imibenconazole, ipconazole, metconazole, myclobutanil, oxpoconazole, pefurazoate, penconazole, prochloraz, propiconazole, prothioconazole, simeconazole, tebuconazole, tetraconazole, triadimefon, triadimenol, triflumizole, triticonazole, diclobutrazol, etaconazole, furconazole, furconazole-cis and quinconazole; a phenyl pyrrole fungicide, such as fenpiclonil and fludioxonil; an anilino-pyrimidine fungicide, such as cyprodinil, mepanipyrim and pyrimethanil; a morpholine fungicide, such as aldimorph, dimethimorph, dodemorph, fenpropimorph, tridemorph, fenpropidin, spiroxamine; piperalin, chlorothalonil; famoxadone; fenamidone; benalaxyl; benalaxyl-M; benomyl; bitertanol; boscalid; carboxin; carpropamid; copper (diverse salts); copper ammonium carbonate; copper octanoate; copper oleate; copper sulphate; copper hydroxide; captan, cyazofamid; cymoxanil; diethofencarb; dithianon; fenhexamide; fenoxycarb; fluazinam; flutolanil; folpet; fosetyl-Al, guazatine; hymexazole; iprodione; mancozeb; metalaxyl; mefenoxam; metrafenone; nuarimol; paclobutrazol; pencycuron; penthiopyrad; procymidone; pyroquilon; quinoxyfen; silthiofam; sulfur; thiabendazole; thiram; triazoxide; tricyclazole; proquinazid; captan; trinexapac-Ethyl; chlormequat chloride; ethephon; and acibenzolar-5-methyl; mineral oils and formulations thereof with fungicidal activity, e.g. Enspray™ 99 by SK; and essential oils and formulations thereof, e.g. tea tree oil, Timorex™, and Timorex™ Gold.

In some of the embodiments in which a fungicidal agent is given by foliar spray, a synergistic interaction is seen between said fungicidal agent and the non-pathogenic bacteria and/or activating agents administered to the plants in the forms of granules and a separately administered foliar spray.

The present invention will now be further illustrated with reference to the following non-limiting working example and accompanying figures.

### EXAMPLE

General Materials and Methods:

1. Non-Pathogenic Bacteria

Bacillus subtilis

For the purpose of the studies reported herein, the commercially-available QST 713 strain was used. This strain was obtained from the Bayer Corporation in two different formulations: 1) Serenade® ASO; and 2) Cease®.

2. Activating Agents

The following phytochemicals were selected for use as activating agents together with B. subtilis in the combination treatment used in the study reported hereinbelow:

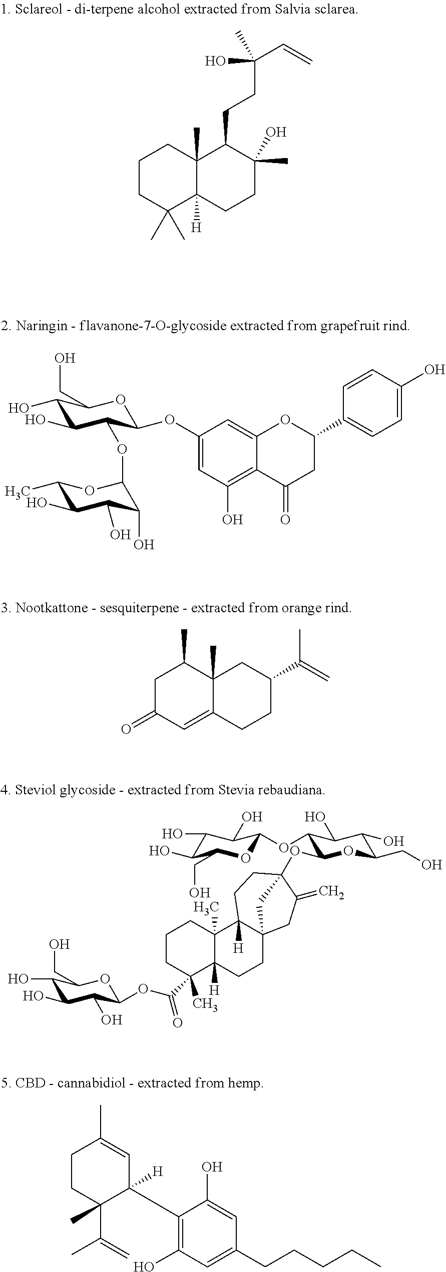

### Example 1

Administration to Cucumber Plants by Two Routes (Granules and Foliar Spray) Compared with Administration by One Route Only

Introduction:

The purpose of this study was to investigate the effect of using two separate routes of administration of a combination of B. subtilis and a mixture of anti-inflammatory activation agents. As described in co-owned WO 2018/051344, this combination (referred to hereinbelow as the “combination treatment” or similar) is highly effective in preventing plant species against infection with a variety of bacterial, viral and fungal pathogens. The different administration routes compared were: (i) granules added to the soil; (ii) foliar spray; and (iii) granules and foliar spray in combination. The effects of the choice of administration route were measured in a field study, in which the levels of mildew contamination (with Peronospora species) in cucumber plants, as well as the cucumber fruit yield from said plants, were recorded. In addition to comparing the effect of administration route, the effect of the co-presence of various anti-fungal agents was also tested.

Materials and Methods:

The baby cucumber variety C2-16-338 was planted in a 50 mesh net tunnel, 36 m long and 9 m wide.

The plants were transplanted at a high density of 6000 plants per 1000 square meters.

Sowing day: 23 Aug. 2018

Planting day: 2 Sep. 2018

The plants were irrigated with 1.6 L drips and fertilized with NPK 7:3:7 at 2 L/cubic meter. Various different fungicide agents (as described below) were applied in a foliar spray on the following dates, using a spray volume of 20 L/1000 square m.

1. 23 Aug. 2018

2. 2 Sep. 2018

3. 16 Sep. 2018

Various treatment regimens were used in order to compare the effect of administering the combination treatment via various administration routes, with/without commercial fungicides. In each case (with the exception of the control, treatment no. 2), both the granules and foliar spray (where used) contained the combination treatment (i.e. the combination of B. subtilis and the activating agents. The regimens used were as follows:

| | TREATMENT | | | | | |
|---|---|---|---|---|---|---|
| | Combination | Combination | FUNGICIDE | | | |
| | treatment in | treatment in | (administered in | | | |
| # | GRANULES | FOLIAR SPRAY | foliar spray) | CONCENTRATION | | REPLICATES |
| 1 | ✓ | X | X | 2 | kg/Dunam | 6 |
| 2 | X (Control) | X (Control) | X (Control) | — | | 6 |
| 3 | ✓ | ✓ | 722 g/l | 0.25% | | 6 |
| | | | Propamocarb | | | |
| | | | (Dynon) | | | |
| 4 | X | ✓ | 722 g/l | 0.25% | | 6 |
| | | | Propamocarb | | | |
| | | | (Dynon) | | | |
| 5 | ✓ | ✓ | Manzidan | 250 | g/Dunam | 6 |
| 6 | X | ✓ | Manzidan | 250 | g/Dunam | 6 |
| 7 | ✓ | ✓ | Rodeo 480 g/l | 25 | cc/Dunam | 6 |
| | | | Mefenoxam | | | |
| 8 | X | ✓ | Rodeo 480 g/l | 25 | cc/Dunam | 6 |
| | | | Mefenoxam | | | |

| | | | | | |
|---|---|---|---|---|---|
| 9 | ✓ | ✓ | X | 0.05 | 6 |
| 10 | X | ✓ | X | 0.05 | 6 |

The population size: 40 plants per replicate.

As shown in the above table, the various test treatments are arranged in pairs; in the odd-numbered treatment in each pair (e.g. no. 3, 5 etc.) the combination treatment was administered both in granules and in the foliar spray. The even-numbered treatment in each pair, (nos. 4, 6 etc.), was the same as its odd-numbered partner, with the exception that the combination treatment was present in the granules only (and not in the foliar spray).

Granule Preparation:

Perlite granules were soaked with a liquid solution containing the combination treatment at 1.5 liter per 1 kg granules.

The soaked granules were dried and then soaked again with 1.5 liter per 1 kg and dried once more.

The liquid solution (combination treatment) in which the granules were soaked contained the following agents:

1. Activating agent Emulsion P 91 (see below)—1/20 of the liquid volume.

2. Bacillus subtilis (Serenade) 3% V/V

3. Calirus—1% V/V

The composition of Emulsion P 91 is as follows:

| | Ingredients | per 1 Liter, g | weight, g | % |
|---|---|---|---|---|
| Oil phase | 3 | 8.00 | | 0.8% |
| Oil phase | 5 | 8.00 | | 0.8% |
| Oil phase | 7 | 8.00 | | 0.8% |
| Oil phase | Giralec HE-60 | 50.00 | 50 | 5.00% |
| | (lecithin) | | | |
| Oil phase | MCT | 80.00 | 80 | 8.00% |
| Oil phase | sum oil phase | 154.00 | | 15.40% |
| Water phase | PS 750 | 22.00 | 20 | 2.20% |
| Water phase | 4 | 8.00 | | 0.80% |
| Water phase | 6 | 14.00 | | 1.40% |
| Water phase | water | | | 20.00% |
| Water phase | glycerol | | | 60.20% |
| | | | | 24.40% |
| Emulsion | | 1000 | | 100.00% |
| Active Ingr. % | | 4.60% | | |

The emulsion was prepared using a high shear mixer set to droplet size 214.

The numbered emulsion ingredients listed in the above table refer to the five activating agents:
3—Sclareol 98%
4—Naringin 98%
5—Nootkatone 98%
6—Steviol 90%
7—Hemp oil

Results and Discussion:

In the first set of results an assessment of the degree to which the cucumber plants are attacked by organisms of the Peronospora genus was performed. These are organisms belonging to the Oomycetes class, and they (and the lesions that they cause in plant tissues) are commonly known as Downy mildew. This type of mildew is characterized by having initial symptoms that include large yellow areas visible on the upper leaf surface. As the lesions age and mature, they expand rapidly and turn brown.

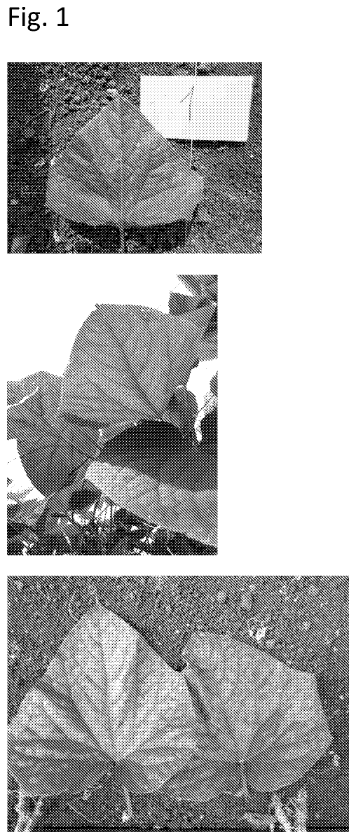

The appearance of this mildew on leaves taken from the treatment 1 group of plants (granules containing the combination treatment; no foliar spray) at three time points is shown in FIG. 1. In this figure, the presence of a small number of discrete yellow lesions may be seen in the upper photograph, which was taken on Sep. 17, 2018. An increase in the number of discrete yellow lesions may be seen in the middle photograph (Sep. 23, 2018), while a marked increase in the number and size of the lesions (which have begun to coalesce) is observed in the lower photograph (Sep. 26, 2018).

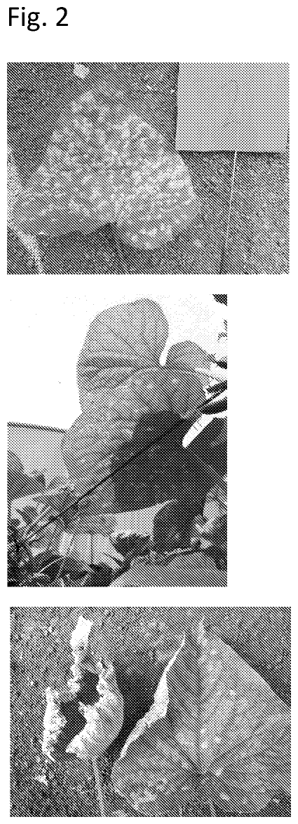

By way of comparison, photographs of plants from the treatment 2 group (negative control; no treatment whatsoever) are shown in FIG. 2. In this case, it is clear that at all three timepoints (September 17, September 23 and September 26; from above to below), the degree of infection is far greater than seen with the granule-only treatment administered to the plants shown in FIG. 1. This is in with regard to the number of discrete lesions, the degree of coalescence of said lesions, and the fact that in the second and third timepoints, a number of more advanced brown-colored lesions are observed.

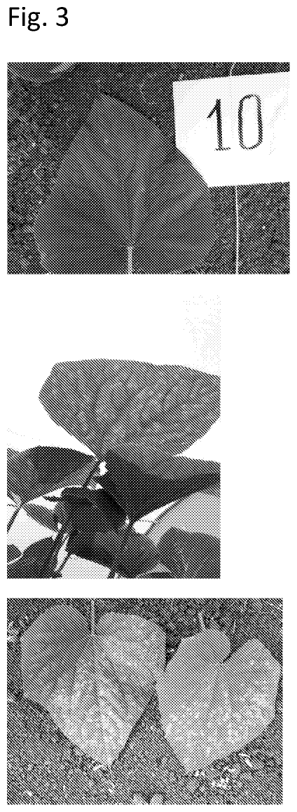

FIG. 3 presents the comparable results for the treatment 10 group of plants, which were the plants that received the combination treatment by foliar spray only. It will be noticed that the results of this treatment are very similar to those seen in the granule-only treatment shown in FIG. 1. The overall number of lesions, the coloration and degree of coalescence is very similar in both of these treatment groups.

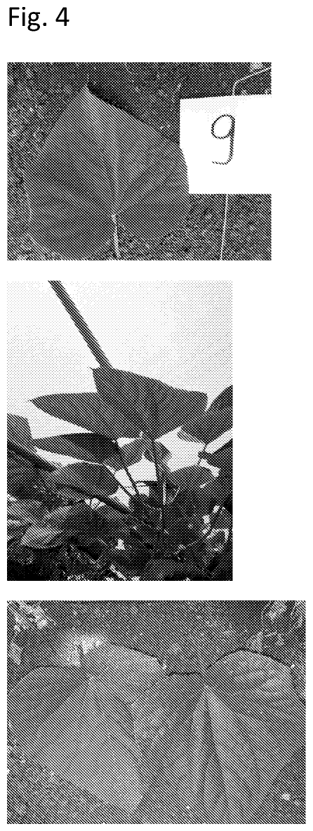

FIG. 4 shows the results at the same three timepoints for the treatment 9 group (combination treatment administered both as granules and as a foliar spray). It is very clear from the photographs in this figure that this combination of two administration routes has caused a dramatic increase in the protection afforded by the treatment to infection by the Downy mildew-forming organisms. Thus, at the first time point (Sep. 17, 2018; upper picture), there is only a very small number of very small-sized discrete yellow lesions. Even at the last timepoint (September 26, lower picture), there are still seen only a very small number of lesions, which have not progressed beyond the early stage of lesion development.

In order to quantify the results for the numbers of lesions observed in each treatment, the actual numbers counted were expressed as an average number per leaf and average number per plant. These values are shown in the following table, which sets out the results for the various treatment groups in increasing order of efficacy with regard to prevention of the mildew formation:

| | | % inoculation | % inoculation |
|---|---|---|---|
| Rx | | (average per | (average per |
| no. | Details of Rx | leaf) | plant) |
| 2 | control not treated | 66 | 55 |
| 1 | Nursery granules (Magen)2 Kg/ | 60 | 51 |
| | Dunam | | |
| 8 | (Rodeo) Mefenoxam 480 g/l SL 25 | 58 | 50 |
| | cc/d | | |
| 10 | Foliar emulsion 0.05% | 55 | 48 |
| 3 | Nursery granules (Magen) + | 47 | 43 |
| | (Dynone) Propamocarb 722 g/l | | |
| | SL 0.25% | | |
| 4 | (Dynone) Propamocarb 722 g/l SL | 44 | 41 |
| | 0.25% | | |
| 6 | (Manzidan) Mancozeb 750 G.R. | 38 | 40 |
| | 250 g/d | | |
| 7 | Nursery granules (Magen) + | 19 | 24 |
| | (Rodeo) Mefenoxam 480 g/l SL | | |
| | 25 cc/d | | |
| 9 | Nursery granules (Magen) + Foliar | 9 | 14 |
| | emulsion 0.05% | | |
| 5 | Nursery granules (Magen) + | 6 | 11 |
| | (Manzidan) Mancozeb 750 G.R. | | |
| | 250 g/d | | |

It may be seen from this table that, as discussed hereinabove with reference to the figures, both the granule treatment only (treatment group 1) and the foliar spray only (treatment group 10) afforded the plants a certain degree of protection against mildew formation. However, significantly greater inhibitory effects were observed with some of the other treatments, particularly the dual-treatment granule and foliar spray (treatment 9) and the same dual-treatment with the addition of the commercially-available fungicide, Mancozeb (treatment 5).

In view of the greatly reduced number of lesions seen in the dual-treatment granule and foliar spray group (treatment 9) when compared with granule-only or foliar spray-only treatments (groups 1 and 10, respectively), these results are highly suggestive of a synergistic interaction between the two different modes of administering the combination.

In the second set of results an assessment of the yield of the cucumber fruit in each treatment group was made, and summarized in the following table:

| | Day | | | | | | | | | | | | | | |
|---|---|---|---|---|---|---|---|---|---|---|---|---|---|---|---|
| | 2.9 | 4.9 | 6.9 | 7.9 | 9.9 | 11.9 | 13.9 | 14.9 | 16.9 | 18.9 | 20.9 | 21.9 | 23.9 | 25.9 | |
| | Yield data | | | | | | | | | | | | | | |
| treatments | 1 | 2 | 3 | 4 | 5 | 6 | 7 | 8 | 9 | 10 | 11 | 12 | 13 | 14 | total |
| 1 | 4.7 | 9.2 | 4.5 | 4.9 | 5.2 | 7.2 | 15.4 | 4.54 | 16.5 | 21.9 | 22.2 | 6.62 | 19.5 | 11.9 | 154.18 |
| 2 | 2.2 | 4.1 | 2.1 | 4.35 | 3.5 | 6.9 | 10.7 | 5.28 | 17.2 | 15.7 | 19.3 | 4.3 | 15.1 | 9.42 | 120.1 |
| 3 | 4.6 | 8.7 | 4.1 | 4.8 | 5.5 | 7.6 | 14.3 | 2.81 | 14 | 17.9 | 23.8 | 5.43 | 11.4 | 11.9 | 136.82 |
| 4 | 3.5 | 7 | 3.2 | 2.88 | 4.5 | 6.9 | 8 | 5.98 | 13.1 | 16.5 | 13.5 | 4.29 | 15.8 | 12.9 | 118.09 |
| 5 | 4.9 | 9.1 | 4.5 | 5.83 | 5.6 | 7.5 | 10.2 | 4.85 | 15.3 | 18.5 | 20.5 | 5.08 | 24.5 | 14.5 | 150.74 |
| 6 | 3.4 | 6.8 | 3.1 | 5.2 | 4.5 | 7.1 | 7.7 | 5.88 | 9.68 | 13.7 | 23.7 | 5.5 | 10.6 | 9.1 | 115.96 |
| 7 | 4.5 | 9.1 | 4.4 | 5.8 | 5.5 | 7.2 | 11.7 | 3.52 | 16 | 19.5 | 14.6 | 4.8 | 14.2 | 23.2 | 143.95 |
| 8 | 3.6 | 6.2 | 3 | 5.3 | 4.7 | 5.8 | 8.9 | 3.1 | 12.1 | 12.7 | 17.4 | 4.53 | 13.9 | 8.91 | 110.18 |
| 9 | 4.9 | 10.3 | 4.6 | 7.46 | 5.9 | 8.7 | 15.4 | 2.87 | 10.2 | 15 | 14.1 | 3.97 | 10 | 12.6 | 125.99 |
| 10 | 3.7 | 5.5 | 3.5 | 5.4 | 5.1 | 7.2 | 11.7 | 4.88 | 11.4 | 14.1 | 16.7 | 4 | 10.4 | 9.03 | 112.52 |
| total | 40 | 76 | 37 | 50 | 50 | 72 | 114 | 44 | 135 | 165 | 186 | 49 | 145 | 123 | 1286.9 |
| big | 15 | 20 | 9 | 11 | 10 | 15 | 22 | 6 | 12 | 15 | 17 | 4.6 | 13 | 12 | 180.1 |
| fruits | | | | | | | | | | | | | | | |

As may be seen in this table, all of the treatments containing combination of granules together with the foliar spray (treatments 3, 5, 7, 9) resulted in significantly higher cucumber fruit yield compared to the same treatment without the granules (treatments 4, 6, 8, 10).

These results thus provide further confirmation of the greatly increased efficacy of anti-mildew treatment that is seen when granules containing the combination treatment are administered together with the combination treatment delivered by foliar spray.

### Example 2

### Administration to Grapevine Plants by Two Routes (Granules and Foliar Spray) Compared with Administration by One Route Only

Introduction:

The purpose of this study was to investigate the effect of using two separate routes of administration of a combination of B. subtilis and a mixture of anti-inflammatory activation agents. The different administration routes compared were: (i) granules added to the soil; (ii) foliar spray; and (iii) granules and foliar spray in combination. The effects of the choice of administration route were measured in a field study, in which the levels of mildew contamination (with Plasmopara viticola species) in grapevines.

Materials and Methods:

One-year old grapevines (Vitis vinifera) were planted in a mixture of potter soil (40%)+sand (60%) in individual pots. The various regimens described below were used treat four replicate plants.

Various treatment regimens were used in order to compare the effect of administering the combination treatment via various administration routes, as described in the following table:

| | TREATMENT | | | |
|---|---|---|---|---|
| | | Activating | | |
| | | agent | B. subtilis | FUNGICIDE |
| | Combination | emulsion | (Serenade) | (administered |
| | treatment in | in FOLIAR | in FOLIAR | in foliar |
| # | GRANULES | SPRAY | SPRAY | spray) |
| 1 | X | X | X | X |
| 3 | ✓ 10 g/pot | X | X | X |
| 6 | ✓ 10 g/pot | ✓ 10 ml/l | X | X |
| 7 | ✓ 10 g/pot | ✓ 10 ml/l | ✓ 4 ml/l | X |
| 8 | X | X | ✓ 4 ml/l | X |
| 9 | X | ✓ 10 ml/l | X | X |

The study began on Jul. 25, 2019, and at that time, granules containing the combination treatment (i.e. the emulsion containing the five activating agents described hereinabove in the general materials and methods section and in Example 1, in combination with B. subtilis, as described hereinabove in the same sections) were administered to the soil in proximity to the growing plant in treatment groups 3, 6 and 7 (as defined in the table above). This was the only time that granules were administered to the plants.

The various foliar spray treatments (activating agent emulsion alone, B. subtilis alone or both together) were administered to the plants in treatment groups 6, 7, 8 and 9, four times, at approximately 10 day intervals, on the following dates (all in the year 2019): August 19, August 28, September 6 and September 13.

Treatment group 1 was the untreated, negative control group.

Results and Discussion:

On Sep. 24, 2019, 30 leaves from each treatment group were sampled, and the ability of the various treatments to reduce the severity of the pest infection (i.e. Plasmopara viticola which had naturally infected the plants during their growth) was assessed and measured as the percentage of foliar lesions seen in the untreated negative control plants (group 1). The results of this assessment are set out in the following table:

| | | % Pest |
|---|---|---|
| Treatment | | severity |
| Group # | Treatment | reduction |
| 1 | NEGATIVE CONTOL | 0 |
| 3 | GRANULES ONLY | 55.7 |
| 6 | GRANULES + | 47.7 |
| | FOLIAR EMULSION | |
| 7 | GRANULES + | 71.5 |
| | FOLIAR | |
| | EMULSION + | |
| | FOLIAR B. Subtilis | |
| 8 | FOLIAR SERENADE | 52.5 |
| | ASO ONLY | |
| 9 | FOLIAR EMULSION | 36.7 |
| | ONLY | |

It may be seen from this table that treatment with the activating agent/B. subtilis combination composition in the form of granules only (treatment group 3) afforded the plants a certain degree of protection against mildew formation. Similarly, treatment with the granules and foliar activating agent emulsion spraying (i.e. no foliar B. subtilis; treatment group 6), treatment with activating agent emulsion spraying only (i.e. no foliar B. subtilis or granules; treatment group 9) or treatment with foliar B. subtilis only (i.e. no granules or foliar treatment with activating agents; treatment group 8) all provided a certain reduction in the degree of severity of the mildew infection. However, a significantly greater inhibitory effect was seen when the combination of the activating agents and B. subtilis was administered both in the form of granules and as a foliar spray (treatment group 7). This result demonstrates the superiority of the method of the present invention, to prior art methods involving either the administration of B. subtilis alone or the administration of combinations of B. subtilis and activating agents by one route of administration alone.

1. A method for preventing and/or treating infection of plant species by fungal, mildew-causing, bacterial and/or viral pathogens, wherein said method comprises the steps of:
a) providing a mixture of one or more non-pathogenic bacteria and one or more activating agents; and
b) administering the mixture of step (a) to said plant species, by means of both:
(i) adding a plurality of granules coated with said mixture to the medium in which said plant is growing; and
(ii) applying a foliar spray comprising said mixture to the aerial parts of said plant species.

2. The method according to claim 1, wherein the non-pathogenic bacteria are bacteria of the species Bacillus subtilis.

3. The method according to claim 4, wherein the strain of Bacillus subtilis is the QST 713 strain.

4. The method according to claim 1, wherein the one or more activating agents are substances having anti-inflammatory activity.

5. The method according to claim 1, wherein the one or more activating agents are selected from the group consisting of Sclareol, Naringin, Nootkatone, Steviol glycoside and cannabidiol.

6. The method according to claim 5, wherein the activating agents comprise a mixture of Sclareol, Naringin, Nootkatone, Steviol glycoside and cannabidiol.

7. The method according to claim 1, wherein the infection of the plant species to be prevented and/or treated is caused by a mildew-causing pathogen.

8. The method according to claim 1, further comprising the foliar administration of one or more bactericidal, viricidal, fungicidal and/or herbicidal agents to the plant species.

9. A kit for use in the method defined in claim 1, comprising:
a) A first container containing granules coated with a mixture of one or more non-pathogenic bacteria and one or more activating agents; and
b) A second container containing a liquid composition suitable for administration by foliar spraying, comprising one or more non-pathogenic bacteria and one or more activating agents.

10. The kit according to claim 9, wherein the non-pathogenic bacteria are bacteria of the species Bacillus subtilis.

11. The kit according to claim 9, wherein the one or more activating agents are selected from the group consisting of Sclareol, Naringin, Nootkatone, Steviol glycoside and cannabidiol.

12. The kit according to claim 9, wherein the non-pathogenic bacteria are the QST 713 strain of the species Bacillus subtilis, and the activating agents comprise a mixture of Sclareol, Naringin, Nootkatone, Steviol glycoside and cannabidiol.
